(19) United States
(12) Patent Application Publication
(10) Pub. No.: US 2006/0177666 A1
(43) Pub. Date: Aug. 10, 2006

(54) Curable resin compositions

(76) Inventor: Masanao Kawabe, Fukuoka (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 11/052,074

(22) Filed: Feb. 8, 2005

(51) Int. Cl. B32B 15/04; B32B 27/00

(52) U.S. Cl. 428/411.1; 428/457; 525/132

(57) ABSTRACT

This invention relates to a curable resin composition which shows excellent chemical resistance, dielectric characteristics, heat resistance, flame retardancy and mechanical properties and low water absorption and is suitable for dielectric materials, insulating materials, heat-resistant materials, structural materials and the like. This curable resin composition comprises component (A) or polyphenylene ether resin and component (B) or a solvent-soluble polyfunctional vinyl aromatic copolymer having constitutional units derived from monomers composed of divinyl aromatic compound (a) and monovinyl aromatic compound (b) or, more particularly, having 20 mol % or more of a repeating unit derived from divinyl aromatic compound (a) and constitutional units represented by the following formulas (2) and (3) 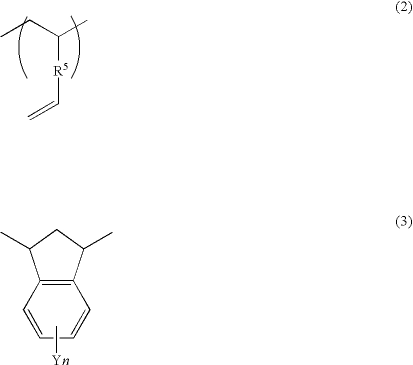
wherein R⁵ represents an aromatic hydrocarbon group containing 6-30 carbon atoms, Y represents an aliphatic hydrocarbon group, an aromatic hydrocarbon group or an unsubstituted or substituted aromatic ring condensed with the benzene ring of the indane ring and n is an integer of 0-4.

### FIELD OF THE INVENTION

This invention relates to curable resin compositions comprising polyphenylene ether resins and soluble polyfunctional vinyl aromatic copolymers, films made from said curable resin compositions and cured products of said films. This invention further relates to curable composite materials comprising said curable resin compositions and base materials, cured products of said curable composite materials, laminates comprising said cured products and metal foils and resin-coated copper foils.

### BACKGROUND OF THE INVENTION

In recent years, a marked trend toward miniaturization and high-packing-density mounting in the field of electronic equipment for communication, household appliances, industries and the like has created a demand for materials with excellent heat resistance, dimensional stability and electrical properties. For example, copper-clad laminates made of a substrate comprising thermosetting resins such as phenol resins and epoxy resins have been used as printed wiring boards. The laminates of this kind have a good balance of various properties, but they have a drawback in that the resins have undesirable electrical properties, particularly undesirably high dielectric properties in a high frequency region. Polyphenylene ether resins are attracting attention in recent years as a new material capable of solving the aforementioned problem, and it has been attempted to apply polyphenylene ether resins to copper-clad laminates and the like.

One of the methods for utilizing polyphenylene ether resins is mixing them with curable resins and monomers. Polyphenylene ethers combined with curable resins and monomers afford the materials with improved chemical resistance and excellent dielectric properties originated from chemical structure of polyphenylene ether resins. Such curable resins and monomers include epoxy resins, 1,2-polybutadiene, polyfunctional maleimides, polyfunctional cyanate esters, polyfunctional acryloyl compounds, triallyl isocyanurate and isocyanate compounds.

In JP6-179734A are disclosed curable composite materials consisting of (a) reaction products of polyphenylene ether resins with unsaturated carboxylic acid and the like, (b) dially phthalate, divinylbenzene, polyfunctional acryloyl compounds, polyfunctional methacryloyl compounds, polyfunctional maleimides, polyfunctional cyanate esters, polyfunctional isocyanates, unsaturated polyesters and the like, (c) thermoplastic resins and (d) base materials. The potential use of divinylbenzene or its prepolymers as component (b) is disclosed there; however, what is actually disclosed in the accompanying examples are merely the reaction products of polyphenylene ether resins with unsaturated carboxylic acids or unsaturated carboxylic acid anhydrides as component (a) and divinylbenzene as component (b). Moreover, curable compositions prepared by this method show poor compatibility of component (a) with component (b) and the cured products of said curable compositions have insufficient properties in heat resistance, external appearance, chemical resistance and mechanical properties; in addition, they pose problems in applications on a commercial basis because of a narrow process window and instability of the mechanical properties of products.

In consequence, there is no suggesting curable resin compositions comprising polyphenylene ether resins and solvent-soluble polyfunctional vinyl aromatic copolymers would have good compatibility, would solve various problems associated with the conventional technology and would afford valuable materials useful in the high-technology field.

An object of this invention is to provide curable resin compositions which have excellent chemical resistance, dielectric characteristics and heat resistance after curing, and can be used as dielectric materials, insulating materials and heat-resistant materials in the electronic, space and aircraft industries, cured products of said curable resin compositions and materials containing said cured products.

### SUMMARY OF THE INVENTION

This invention relates to a curable resin composition which comprises component (A) a polyphenylene ether resin having a constitutional unit represented by the following formula (1) 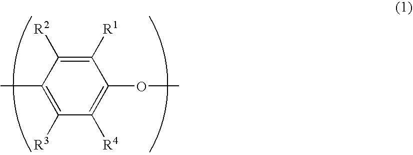
wherein R¹ and R⁴ each independently represent halogens, primary or secondary lower alkyl groups, aromatic hydrocarbon groups such as phenyl, haloalkyl groups, aminoalkyl groups, hydrocarbyloxy groups or halohydrocarbyloxy groups with halogen separated from oxygen by at least two carbon atoms and R² and R³ each independently represent hydrogen, halogens, primary or secondary alkyl groups, aromatic hydrocarbon groups such as phenyl, haloalkyl groups, hydrocarbyloxy groups or halohydrocarbyloxy groups with halogen separated from oxygen by at least two carbon atoms; and component (B) a solvent-soluble polyfunctional vinyl aromatic copolymer having constitutional units derived from divinyl aromatic compound (a) and monovinyl aromatic compound (b) or, more particularly, having 20 mol % or more of a repeating unit derived from divinyl aromatic compound (a) and constitutional units represented by the following formulas (2) and (3) 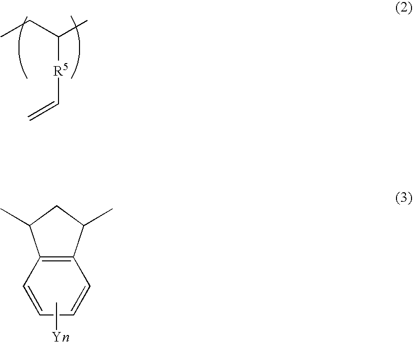
wherein R⁵ represents an aromatic hydrocarbon group containing 6-30 carbon atoms, Y represents a saturated or unsaturated aliphatic hydrocarbon group, an aromatic hydrocarbon group or an unsubstituted or substituted aromatic ring condensed with the benzene ring of the indane ring and n represents an integer of from 0 to 4 and is formulated from 30-98 wt % of component (A) and 2-70 wt % of component (B) on the basis of the sum of components (A) and (B).

In the curable resin composition of the present invention, a thermoplastic resin as component (C) and a filler as component (D) may be incorporated in addition to components (A) and (B). In this case, it is preferable that component (C) accounts for 2-40 wt % of the sum of components (A), (B) and (C) and component (D) accounts for 2-90 wt % of the sum of components (A), (B), (C) and (D).

The present invention further relates to a film molded from the aforementioned curable resin composition. Still further, the present invention relates to a curable composite material comprising the aforementioned curable resin composition and a base material and the proportion of the base material is 5-90 wt %. This invention further relates to a cured composite material obtained by curing the aforementioned curable composite material. Furthermore, this invention relates to a laminate comprising at least one layer of the aforementioned cured composite material and a metal foil. This invention further relates to a resin-coated metal foil having a layer of the aforementioned curable resin composition formed on one side of a metal foil.

In the aforementioned curable resin composition, it is advantageous for component (3) or a polyfunctional vinyl aromatic copolymer to have 20 mol % or more of a repeating unit derived from divinyl aromatic compound (a), constitutional units represented by formula (2) and the following formula (4) 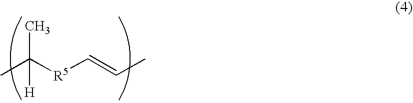
(wherein R⁵ represents an aromatic hydrocarbon group containing 6-30 carbon atoms) in a ratio of 50 mol % or more as the mole fraction of the constitutional unit represented by formula (2) to the sum of the constitutional units represented by formulas (2) and (4) and an indane unit represented by formula (3) in the backbone.

### DETAILED DESCRIPTION OF THE PREFERRED EMBODIMENTS

A polyphenylene ether resin (hereinafter referred to as PPE resin) to be used as component (A) according to the present invention is a plastic material that has a constitutional unit represented by the aforementioned formula (1), can be molded into finished articles and parts of desired shape by a molding process such as injection and extrusion and is used widely as a material for making finished articles and parts in the electrical and electronic industries, automotive industry and other industries supplying a variety of industrial materials. Modified PPE resins may serve as well as PPE resins.

The groups R¹ and R⁴ in formula (1) each independently represent halogens, primary or secondary lower alkyl groups, haloalkyl groups, aminoalkyl groups, hydrocarbyloxy groups, aromatic hydrocarbon groups or halohydrocarbyloxy groups (wherein halogen is separated from oxygen by at least two carbon atoms) while R² and R³ each independently represent hydrogen, halogens, primary or secondary lower alkyl groups, haloalkyl groups, hydrocarbyloxy groups, aromatic hydrocarbon groups or halohydrocarbyloxy groups (wherein halogen is separated from oxygen by at least two carbon atoms). It is preferable here to choose chlorine or bromine as halogen, an alkyl group containing 1-4 carbon atoms as lower alkyl group, a chlorinated or brominated lower alkyl group as haloalkyl group, a lower alkyloxy group or phenoxy group as hydrocarbyloxy group, and an aromatic hydrocarbon group containing 6-30 carbon atoms such as phenyl and alkylphenyl as aromatic hydrocarbon group. The halohydrocarbyloxy groups are preferably represented by X—R—O— (wherein X is chlorine or bromine and R is an alkylene group containing 2-5 carbon atoms). Furthermore, it is preferable that R² and R³ are hydrogen and R¹ and R⁴ are methyl, ethyl, phenyl or chlorine.

PPE resins in the present invention include both homopolymers or copolymers which preferably have a reduced viscosity in the range of 0.15 to 0.70 dl/g, more preferably in the range of 0.20 to 0.60 dl/g, as measured in 0.5 g/dl chloroform solution at 30° C. Examples of PPE resins are poly(2,6-dimethyl-1,4-phenylene ether), poly(2-methyl-6-ethyl-1,4-phenylene ether), poly(2-methyl-6-phenyl-1,4-phenylene ether) and poly(2,6-dichloro-1,4-phenylene ether).

Other examples of PPE resins are polyphenylene ether copolymers such as copolymers of 2,6-dimethylphenol and other phenols (for example, 2,3,6-trimethylphenol and 2-methyl-6-butylphenol). Poly(2,6-dimethyl-1,4-phenylene ether) and a copolymer of 2,6-dimethylphenol and 2,3,6-trimethylphenol are preferably used. The most preferred PPE resin is poly(2,6-dimethyl-1,4-phenylene ether).

The methods for preparing PPE resins are not limited to any particular one and, according to a method described in U.S. Pat. No. 3,306,874, 2,6-xylenol is submitted to oxidative polymerization in the presence of a catalyst which is a cuprous salt-amine complex. Other methods useful for the preparation of PPE resins are described in U.S. Pat. No. 3,306,875, U.S. Pat. No. 3,257,357, U.S. Pat. No. 3,257,358, JP52-17880B, JP50-51197A, JP63-152628A and elsewhere.

It is allowable for component (A) of PPE resin to comprise a constitutional unit represented by the following general formula (5) in addition to the constitutional unit of PPE resin represented by general formula (1) as long as the PPE resin does not suffer degradation of its heat resistance and thermal stability: 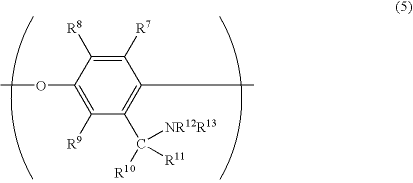
in general formula (5), R⁷, R⁸ and R⁹ respectively correspond to R¹, R² and R³ in formula (1); R¹⁰ and R¹¹ each independently represent hydrogen, halogens, alkyl groups containing 1-10 carbon atoms, preferably 1-5 carbon atoms, aryl groups or haloalkyl groups containing 1-10 carbon atoms, preferably 1-5 carbon atoms; R¹² and R¹³ each independently represent hydrogen, alkyl groups containing 1-10 carbon atoms, preferably 1-5 carbon atoms, either unsubstituted or substituted with aryl groups or with halogens or aryl groups either unsubstituted or substituted with alkyl groups containing 1-10 carbon atoms, preferably 1-5 carbon atoms, or with halogens and R¹² and R¹³ do not represent hydrogen simultaneously.

The constitutional unit represented by formula (5) is formed during the preparation of PPE resin by the reaction between the terminal quinonemethide or phenoxy group of the polymer and the amine compound as a catalyst component.

The soluble polyfunctional vinyl aromatic copolymers useful as component (B) of a curable resin composition of the present invention are copolymers having constitutional units derived from monomers composed of divinyl aromatic compound (a) and monovinyl aromatic compound (b). Moreover, the copolymers contain 20 mol % or more of the repeating unit derived from divinyl aromatic compound (a).

The copolymers contain the constitutional units represented by the aforementioned formulas (2) and (3) as repeating units derived from divinyl aromatic compound (a). The symbols R⁵, Y and n in formulas (2) and (3) are as defined above and are determined by the kind of divinyl aromatic compounds (a) and monovinyl aromatic compounds (b) and by the reaction conditions such as the catalyst system.

The compounds useful as divinyl aromatic compound (a) include, but are not limited to, m-divinylbenzene, p-divinylbenzene, 1,2-diisopropenylbenzene, 1,3-diisopropenylbenzene, 1,4-diisopropenylbenzene, 1,3-divinylnaphthalene, 1,8-divinylnaphthalene, 1,4-divinylnaphthalene, 1,5-divinylnaphthalene, 2,3-divinylnaphthalene, 2,7-divinylnaphthalene, 2,6-divinylnaphthalene, 4,4′-divinylbiphenyl, 4,3′-divinylbiphenyl, 4,2′-divinylbiphenyl, 3,2′-divinylbiphenyl, 3,3′-divinylbiphenyl, 2,2′-divinylbiphenyl, 2,4-divinylbiphenyl, 1,2-divinyl-3,4-dimethylbenzene, 1,3-divinyl-4,5,8-tributylnaphthalene and 2,2′-divinyl-4-ethyl-4′-propylbiphenyl. These compounds may be used individually or in combination.

Preferable examples of divinyl aromatic compound (a) are divinylbenzene (both m- and p-isomers), divinylbiphenyl (including various isomers) and divinylnaphthalene (including various isomers) from the view point of the cost of the divinyl compounds and the heat resistance of the resulting polymers. Divinylbenzene (both m- and p-isomers) and divinylbiphenyl (including various isomers) are more preferable and divinylbenzene (both m- and p-isomers) is particularly suitable for use. In the applications where high heat resistance is required, divinylbiphenyl (including various isomers) and divinylnaphthalene (including various isomers) are used advantageously.

The compounds useful as monovinyl aromatic compound (b) include styrene, styrene derivatives with alkyl substituents onto the aromatic ring, aromatic vinyl compounds, aromatic vinyl compounds with alkyl substituents onto the aromatic ring, α-alkyl styrenes, β-alkyl styrenes, styrene derivatives with alkoxy substituents onto the aromatic ring, indene derivatives and acenaphthylene derivatives.

In the case of styrene derivatives with alkyl substituents onto the aromatic ring, there is no restriction on the position where the substitution occurs as long as hydrogen is available there for the substitution. The alkyl substituents preferably contain 1-6 carbon atoms and the number of substituent alkyl groups is preferably 1 or 2. The examples of styrene derivatives with alkyl substituents onto the aromatic ring include methylstyrene, ethylstyrene, propylstyrene, n-butylstyrene, isobutylstyrene, t-butylstyrene, pentylstyrene, hexylstyrene and cyclohexylstyrene.

In the case of alkoxy-substituted styrenes, there is no restriction on the substitutive position where substitutive hydrogen is available. The alkoxy substituents preferably contain 1-6 carbon atoms and the number of alkoxy substituents is preferably 1 or 2. The examples of alkoxy-substituted styrenes include methoxystyrene, ethoxystyrene, propoxystyrene, n-butoxystyrene, isobutoxystyrene, t-butoxystyrene, pentoxystyrene, hexoxystyrene and cyclohexoxystyrene. Also useful are o-phenoxystyrene, m-phenoxystyrene and p-phenoxystyrene.

The preferred examples of aromatic vinyl compounds for the present invention include 2-vinylbiphenyl, 3-vinylbiphenyl, 4-vinylbiphenyl, 1-vinylnaphthalene and 2-vinylnaphthalene.

In the case of aromatic vinyl compounds substituted with alkyl groups in the ring, there is no restriction on the position where the vinyl and alkyl groups are substituted as long as hydrogen atoms are available there for the substitution. The substituent alkyl groups preferably contain 1-6 carbon atoms and the number of substituent alkyl groups is preferably 1 or 2. Ethylvinylbiphenyl and ethylvinylnaphthalene can be used as aromatic vinyl compound substituted with alkyl groups in the ring.

Examples of styrenes with alkyl substituents onto the α-carbon useful in practicing this invention are α-methylstyrene, α-ethylstyrene and α-propylstyrene. The substituent alkyl group may be either linear or branched.

The indene derivatives useful in practicing this invention include indene and alkyl-substituted indenes such as methylindene and ethylindene. In addition, alkoxyindenes such as methoxyindene, ethoxyindene and butoxyindene may be used. The subsitutent alkyl and alkoxy groups may be either linear or branched.

The acenaphthylene derivatives include acenaphthylene, alkyl substituted acenaphthylenes such as methylacenaphthylene and ethylacenaphthylene, halogenated acenaphthylenes such as cHloroacenaphthylene and bromoacenaphthylene and phenyl substituted acenaphthylenes such as phenylacenaphthylene. The substitution may take place at any of the positions 1, 3, 4 and 5.

The compounds suitable for use as monovinyl aromatic compound (b) are not limited to the aforementioned examples and, furthermore, they may be used singly or as a mixture of two kinds or more.

The soluble polyfunctional vinyl aromatic copolymers of the present invention comprises the aforementioned divinyl aromatic compound (a) 20 mol % or more based on the total number of moles of monomers composed of divinyl aromatic compounds (a) and monovinyl aromatic compounds (a). The rate is preferably 30 mol % or more, more preferably 40 mol % or more, most preferably 50 mol % or more. When the content of divinyl aromatic compound (a) fall to less than 20 mol %, the resulting soluble polyfunctional vinyl aromatic copolymers tend to afford cured compositions with poor heat resistance. It is advantageous that the copolymers contain 50-98 mol % of the repeating unit derived from divinyl aromatic compound (a) and 1 mol % or more, preferably 2-50 mol %, of the repeating unit derived from monovinyl aromatic compound (b).

Furthermore, it is necessary that the copolymers as component (B) should consist of the constitutional units represented by the aforementioned formulas (2) and (3) in the backbone. The indane structure represented by formula (3) is formed from the terminal constitutional units of growing polymer chains derived from divinyl aromatic compound (a) and monovinyl aromatic compound (b), when the polymerization is carried out according to a method described in the examples of this invention. The proportion of the aforementioned indane structure to the constitutional units of the entire monomers is desirably 0.01 mol % or more. The proportion is preferably 0.1 mol % or more, more preferably 1 mol % or more, most preferably 3 mol % or more. It is most desirable that the proportion is 5 mol % or more. It is advantageous to have the indane structure in the range of 0.5-20 mol %. The lack of the aforementioned indane structure in the backbone of polyfunctional vinyl aromatic copolymers of this invention causes an undesirable insufficiency of the heat resistance and solubility in solvents.

Moreover, in the backbone of the polymers to be used as component (B), the mole fraction of the constitutional unit represented by formula (2) is preferably 50 mol % or more to based on the total number of moles of the constitutional units represented by formulas (2) and (4), more preferably 70 mol % or more, most preferably 90 mol % or more.

When the mole fraction of the constitutional unit represented by formula (2) is in the range of less than 50 mol %, the compatibility between component (A) and component (B) deteriorates thereby causing the heat resistance and mechanical properties to deteriorate.

The number average molecular weight (Mn) of the soluble polyfunctional vinyl aromatic copolymers to be used as component (B) is preferably 300-100000, more preferably 400-50000, most preferably 500-20000. The molecular weight distribution (Mn/Mw) derived from Mn and the weight average molecular weight (Mw) is preferably 20 or less. The Mn and Mw are measured by gel permeation chromatography using the calibration based on standard polystyrene samples with narrow molecular weight distributions. Where Mn is less than 300, the copolymers become too low in viscosity and difficult to process. Where Mn is in excess of 100000, gels tend to form easily. Where the molecular weight distribution exceeds 20, the copolymers have disadvantageous poor processibility and formation of gels.

The content of metal ions in the soluble polyfunctional vinyl aromatic copolymers to be used as component (B) is preferably 100 ppm or less, preferably 1 ppm or less, for each metal ion. The electrical properties of the copolymers deteriorate when the content of metal ions is 100 ppm or more.

The soluble polyfunctional vinyl aromatic copolymers to be used as component (B) may be copolymers prepared by polymerizing the aforementioned monomer components with trivinyl aromatic compounds and other divinyl and monovinyl compounds to the extent that does not adversely affect the effect of this invention.

Concrete examples of the trivinyl aromatic compounds are 1,2,4-trivinylbenzene, 1,3,5-trivinylbenzene, 1,2,4-triisopropenylbenzene, 1,3,5-triisopropenylbenzene, 1,3,5-trivinylnaphthalene and 3,5,4′-trivinylbiphenyl. The other vinyl compounds are exemplified by dienes such as butadiene and isoprene while the other monovinyl compounds are exemplified by alkyl vinyl ethers, aromatic vinyl ethers, isobutene and diisobutylene. These compounds may be used singly or as a mixture of two kinds or more and they are used in an amount corresponding to less than 30 mol % of the entire monomers including divinyl aromatic compound (a) and monovinyl aromatic compound (b).

The soluble polyfunctional vinyl aromatic copolymers to be used as component (B) can be obtained, for example, by polymerizing the monomer components including divinyl aromatic compound (a) and monovinyl aromatic compound (b) in either a single organic solvent or a mixture of organic solvents with a dielectric constant of 2-15 at 20-100° C. in the presence of a Lewis acid catalyst and an initiator represented by the following formula (6) 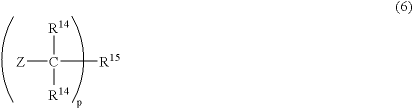
wherein R¹⁴ represents a hydrogen atom or a monovalent hydrocarbon group containing 1-6 carbon atoms, R¹⁵ is an aromatic or aliphatic hydrocarbon group with a valence of p, Z is a halogen atom or an alkoxyl or acyloxy group containing 1-6 carbon atoms and p is an integer of 1-6. In the case where a plurality of R¹⁴ or Z are present in a molecule, the groups designated by R¹⁴ or Z may be either identical with or different from one another.

Upon termination of the polymerization reaction, the copolymers are recovered by a method that is not restricted, for example, by a common method such as steam stripping and separation by a poor solvent.

In formulating the curable resin compositions of this invention, the ratio of component (A) to component (B) by weight can be varied in a wide range, but the following relationships must be satisfied:
Proportion of component (A)=(A)/[(A)+(B)]=0.3-0.98
Proportion of component (B)=(B)/[(A)+(B)]=0.02-0.7

It is preferable to set the proportion of component (A) at 0.5-0.95 and the proportion of component (B) at 0.05-0.50. The chemical resistance does not improve sufficiently when the proportion of component (B) is less than 2 wt %, while the mechanical properties deteriorate when the proportion of component (B) exceeds 70 wt %.

In addition to components (A) and (B), one kind or two kinds or more of thermoplastic resins may be incorporated as component (C) in the curable resin compositions of this invention. In this case, the proportion of component (C) must satisfy the following relationship:
Proportion of component (C)=(C)/[(A)+(B)+(C)]=0.02-0.4

The proportion of component (C) is preferably 0.05-0.2. The mechanical properties deteriorate when component (C) is less than 2 wt % while the chemical resistance deteriorates when component (C) exceeds 40 wt %.

Thermoplastic resins suitable for use as component (C) include polyolefins such as polyethylene, polypropylene, ethylene-propylene copolymers, poly(4-methylpentene) and their derivatives, polyamides such as nylon 4, nylon 6, nylon 66 and their derivatives, polyesters such as polyethylene terephthalate and polybutylene terephthalate and their derivatives, polyphenylene ethers, modified polyphenylene ethers, polycarbonates, polyacetals, polysulfones, vinyl chloride polymers and copolymers, vinylidene chloride polymers and copolymers, polymethyl methacrylates, acrylate (or methacrylate) copolymers, polystyrenes, styrenic copolymers such as acrylonitrile-styrene copolymers and acrylonitrile-butadiene-styrene copolymers, polyvinyl acetates, ethylene-vinyl acetate copolymers and their hydrolyzates, styrene-butadiene block copolymers, rubbers such as polybutadiene and polyisoprene, polyvinyl ethers such as polymethoxyethylene and polyethoxyethylene, polyphosphazenes, polyethersulfones, polyetherketones, polyetherimides, polyphenylene sulfides, polyamideimides, thermoplastic polyimides, liquid crystal polymers such as aromatic polyesters and thermoplastic block copolymers containing at least one functional group selected from epoxy group, carboxylic acid group and maleic anhydride group.

Of the aforementioned thermoplastic resins, styrene-butadiene block copolymers are preferred from the standpoint of improving the mechanical properties.

In addition to components (A), (B) and (C), fillers may be incorporated as component (D) to the curable resin compositions of this invention. In this case, the proportion (on a weight basis) of component (D) must satisfy the following relationship:
Proportion of component (D)=(D)/[(A)+(B)+(C)+(D)]=0.02-0.9

The proportion of component (D) is preferably 0.2-0.85. The mechanical properties do not improve sufficiently when less than 2 wt % of component (D) is added while the fluidity of the resin composition drops markedly when more than 90 wt % of component (D) is added.

Fillers suitable for use as component (D) include carbon black, silica, alumina, talc, mica, glass beads and hollow glass spheres. Fillers may be fibrous or powdery.

It is allowable to add crosslinking components other than component (B) as component (E) to the curable resin compositions of this invention to the extent that the addition does not adversely affect the effect of this invention. The compounds useful for component (E) include dially phthalate, polyfunctional acryloyl compounds, polyfunctional methacryloyl compounds, polyfunctional maleimides, polyfunctional cyanate esters, polyfunctional isocyanates and unsaturated polyesters and prepolymers of these compounds. They are used singly or as a mixture of two kinds or more.

Diallyl phthalate has ortho, meta and para isomers and any of the isomers can be used as component (E).

The polyfunctional (meth)acryloyl compounds are typically represented by the following formulas 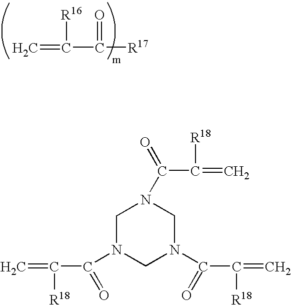
wherein m is an integer of 2-10, R¹⁶ and R¹⁸ are hydrogen or methyl and R¹⁷ is the residue of a polyhydroxy compound.

In the aforementioned formula, R¹⁷ is exemplified by the residues of the following polyfunctional hydroxy compounds: alkanepolyols such as ethylene glycol, propylene glycol and butanediol; polyetherpolyols such as diethylene glycol; aromatic polyols consisting of a plurality of benzene rings linked together by bridging components, typically bisphenol A, and their adducts with alkylene oxides.

Examples of the aforementioned polyfunctional (meth)acryloyl compounds are ethylene glycol diacrylate, propylene glycol diacrylate, 1,4-butanediol diacrylate, pentaerythritol tetraacrylate, polyethylene glycol diacrylate, bisphenol A diacrylate, polyacrylates of precondensates of phenolic resins, epoxy acrylates obtained by the reaction of acrylic acid with bisphenol A-based epoxy resins, novolak epoxy resins, alicyclic epoxy resins or diglycidyl phthalate and polycarboxylic acids, polyesterpolyacrylates obtained by the reaction of polyesters containing two or more terminal hydroxyl groups with acrylic acid, the aforementioned polyacrylates in which acrylate is replaced by methacrylate, and their partially halogenated derivatives.

Examples further include hexahydro-1,3,5-triacryloyl-s-triazine and hexahydro-1,3,5-trimethacryloyl-s-triazine.

Some of the polyfunctional maleimides are represented by the following formula 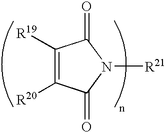
wherein n is an integer of 2-10, R¹⁹ and R²⁰ are hydrogen, halogens or lower alkyl groups and R²¹ is an aromatic or aliphatic organic group with a valence of 2-10.

The aforementioned polyfunctional maleimides are prepared by the reaction of maleic anhydride or its derivative with a polyamine containing 2-10 amino groups to form a maleamic acid followed by the ring closure of the maleamic acid with elimination of water.

The polyamines suitable for use include m-phenylenediamine, p-phenylenediamine, melamines containing an s-triazine ring and polyamines obtained by the reaction of aniline with formaldehyde (normally, polyamines containing 10 benzene rings or less are preferred).

Some of the polyfunctional cyanate esters are represented by the following formula 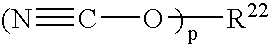
wherein p is an integer of 2-10, R²² is an aromatic organic group with a valence of 2-10 and the cyanate ester group is directly linked to the aromatic ring of R²².

Examples of the aforementioned polyfunctional cyanate esters are 1,3-dicyanatobenzene, 1,4-dicyanatobenzene, 1,3,5-tricyanatobenzene, 1,3-dicyanatonaphthalene and polycyanato compounds containing plural benzene rings obtained by the reaction of a phenolic resin with a cyanogen halide.

Some of the polyfunctional isocyanates are represented by the following formula 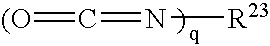
wherein q is an integer of 2-10 and R²³ is an aromatic or aliphatic organic group with a valence of 2-10.

Examples of the aforementioned polyfunctional isocyanates are 2,4-toluene diisocyanate, 2,6-toluene diisocyanate, m-phenylene diisocyanate and p-phenylene diisocyanate.

These polyfunctional isocyanates are used after conversion to polyfunctional blocked isocyanates with the use of a variety of known blocking agents, for example, alcohols, phenols, oximes, lactams, malonate esters, acetoacetate esters, acetylacetone, amides, imidazoles and sulfite salts.

Unsaturated polyesters are generally obtained by the reaction of glycols with unsaturated and saturated polybasic acids or with the anhydrides, esters or acid chlorides of these unsaturated and saturated polybasic acids and such unsaturated polyesters are used in this invention.

Typical glycols include ethylene glycol, propylene glycol, diethylene glycol and bisphenol A-propylene oxide adducts.

Typical examples of unsaturated polybasic acids are maleic anhydride, fumaric acid and itaconic acid and those of saturated polybasic acids are phthalic anhydride, isophthalic acid, terephthalic acid and tetrahydrophthalic anhydride.

For details of unsaturated polyesters, reference should be made, for example, to Raymond W. Meyer, Ed., “Handbook of Polyester Molding Compounds and Molding Technology,” Chapman & Hall, 1987.

When component (E) is incorporated in a curable resin composition of this invention, it is allowable to select as component (E) only one kind or a combination of two kinds or more of compounds from the aforementioned group of compounds. It is also allowable to use prepolymers of the aforementioned selected compounds as component (E) of this invention; the prepolymers are preliminarily formed by application of heat or light in the presence or absence of known catalysts, initiators, curing agents and the like to be described later as component (E) of this invention.

A curable resin composition of this invention cures by a crosslinking reaction caused by such means as heating as described later and a radical initiator may be incoroprated in the composition to lower the reaction temperature or accelerate the crosslinking reaction of unsaturated groups. A radical initiator useful for this purpose is added in an amount corresponding to 1.1-10 wt %, preferably 0.1-8 wt %, of the sum of components (A) and (B).

Typical examples of radical initiators are peroxides such as benzoyl peroxide, cumene hydroperoxide, 2,5-dimethylhexane-2,5-dihydroperoxide, 2,5-dimethyl-2,5-di(t-butylperoxy)hexyne-3, di-t-butyl peroxide, t-butylcumyl peroxide, α,α′-bis(t-butylperoxy-m-isopropyl)benzene, 2,5-dimethyl-2,5-di(t-butylperoxy)hexane, dicumyl peroxide, di-t-butylperoxy isophthalate, t-butylperoxy benzoate, 2,2-bis(t-butylperoxy)butane, 2,2-bis(t-butylperoxy)octane, 2,5-dimethyl-2,5-di(benzoylperoxy)hexane, di(trimethylsilyl) peroxide and trimethylsilyl triphenylsilyl peroxide. Although a non-peroxide, 2,3-dimethyl-2,3-diphenylbutane can also be used as a radical initiator. The radical initiators useful in curing the resin compositions of this invention are not limited to the aforementioned compounds.

The following compounds are useful as curing agents and catalysts for the constituents of component (E): polyamines as curing agents for the polyfunctional maleimides; mineral acids, Lewis acids, salts such as sodium carbonate and lithium chloride and phosphorus compounds such as tributylphosphine as catalysts for the polyfunctional cyanate esters; and amines, organometallic compounds and polyhydric alcohols such as described in Gunter Oertel, Ed., “Polyurethane Handbook: Chemistry-Raw Materials-Processing-Application-Properties,” Hanser Gardner Pub., 1993 as catalysts and curing agents for the polyfunctional isocyanates.

The aforementioned catalysts, initiators and curing agents are suitably selected in consideration of the presence or absence of component (E) or the kind of component (E). Additives may be incorporated in resin compositions of this invention for the purpose of giving the resin compositions an ability to perform as required by the end use provided that the additives are incorporated in such an amount as not to cause the loss of original properties. Such additives include antioxidants, thermal stabilizers, antistatic agents, plasticizers, pigments, dyes and colorants. To improve the flame retardancy still more, flame retardants based on chlorinated, brominanted or phosphorus compounds and synergists such as Sb₂O₃, Sb₂O₅, NbSbO₃.1/4H₂O may be used together with the aforementioned additives. A combination of brominated diphenyl ether and antimony oxide is preferably used in composite materials containing base materials.

In the preparation of a curable resin composition of this invention, the components are mixed, for example, by solution mixing thereby the components are uniformly dissolved or dispersed in a solvent or by blending thereby the components are agitated and blended by a Henschel mixer and the like. The solvents useful for solution mixing include aromatic solvents such as benzene, toluene and xylene and tetrahydrofuran and they are used singly or as a combination of two kinds or more. A curable resin composition of this invention may be molded in advance into a desired shape for a particular application. The method for molding is not restricted and, normally, a resin composition is dissolved in one of the aforementioned solvents and molded into a desired shape by casting or a resin composition is melted under heat and molded into a desired shape.

Curable resin compositions of this invention are cured to give cured products. The method for curing is optional and any of the methods based on heat, light and electron rays may be adopted. The temperature for curing by heating is set in the range of 80-300° C., preferably in the range of 120-250° C., although it varies with the kind of radical initiator. The period for curing is from 1 minute to 10 hours, preferably from 1 minute to 5 hours.

Curable resin compositions of this invention, like curable composite materials to be described below, can be used laminated to metal foils (metal foils include metal plates here and hereinafter).

Curable composite materials and their cured products based on curable resin compositions of this invention are described next. Curable composite materials are prepared by adding base materials to curable resin compositions of this invention to enhance the mechanical strength and dimensional stability.

Base materials of this kind include woven or nonwoven fabrics obtained from a variety of glass cloths such as roving cloth, cloth, chopped mat and surfacing mat, asbestos cloths, metal fiber cloths, synthetic or natural inorganic fiber cloths, woven or nonwoven fabrics obtained from liquid crystal fibers such as full aromatic polyamide fibers, full aromatic polyester fibers and polybenzoxazole fibers, woven or nonwovn fabrics obtained from synthetic fibers such as polyvinyl alcohol fibers, polyester fibers and acrylic fibers, cotton cloths, flax cloths, natural fiber cloths such as felts, carbon fiber cloths, natural cellulosic cloths such as kraft paper, cotton paper, glass fiber-blended paper and papers and they are used singly or as a mixture of two kinds or more.

The proportion of base materials in curable composite materials is 5-90 wt %, preferably 10-80 wt %, more preferably 20-70 wt %. A curable composite material containing less than 5 wt % of base material shows insufficient dimensional stability and strength after curing while the one containing more than 90 wt % of base material undesirably shows inferior dielectric characteristics.

Coupling agents may be incorporated in curable composite materials of this invention for the purpose of improving the adhesiveness at the interface between the base material and resin as occasion demands. Commonly known coupling agents can be used for this purpose; for example, silane coupling agents, titanate coupling agents, aluminum-based coupling agents and zircoaluminate coupling agents.

A curable composite material of this invention is prepared, for example, in the following manner: a curable resin composition of this invention, together with other components if necessary, is uniformly dissolved or dispersed in one, or a mixture, of the aforementioned solvents based on aromatic compounds or ketones and a base material is impregnated with the resulting solution or dispersion and dried. Impregnation is effected by such means as dipping and coating. If necessary, impregnation can be repeated several times. It is possible in this case to repeat impregnation by using plural solutions differing in composition and concentration from one another to finally adjust the composition and amount of resins to the desired values.

Curable composite materials of this invention are cured by such means as heating to give cured composite materials. The method for their preparation is not limited to any specific one and a cured composite material of a given thickness can be obtained by placing several sheets of curable composite material one upon another and pressing them together under pressure to effect simultaneously bonding of the sheets and curing of them. Moreover, it is possible to combine an already cured composite material and a curable composite material to give a cured composite material of a new layered structure. Lamination and curing can be effected simultaneously by the use of a hot press or the like or they may be effected separately, for example, composite materials are laminated in advance while uncured or semi-cured and then cured by heat treatment or otherwise.

The molding and curing can be carried out at a temperature in the range of 80-300° C., preferably in the range of 150-250° C., and at a pressure in the range of 0.1-1000 kg/cm², preferably in the range of 1-500 kg/cm², for a period in the range from 1 minute to 10 hours, preferably in the range from 1 minute to 5 hours.

A laminate of this invention is composed of a layer of cured composite material of this invention and a metal foil. The metal foils useful for the laminates are, for example, copper foils and aluminum foils. The thickness of metal foil, although not limited, is 3-200 μm, preferably 3-105 μm.

One of the methods for preparing a laminate of this invention consists, for example, of building up a desired layered structure from sheets of a curable composite material that is prepared from the aforementioned curable resin composition of this invention and a base material and metal foils and simultaneously effecting bonding and curing under heat and pressure. In preparing laminates from curable resin compositions of this invention, cured composite materials and metal foils are laminated at will to build up a desired layered structure. The metal foil can be used as either a surface layer or an intermediate layer. In addition, it is possible to build up a multilayer structure by repeating lamination and curing several times.

It is allowable to use an adhesive for bonding a metal foil to a composite material. Any of adhesives based on epoxy compounds, acrylic compounds, phenolic compounds and cyanoacrylates is satisfactory and the use is not restricted to these adhesives. The aforementioned lamination and curing can be carried out under the same conditions as used for the preparation of cured composite materials of this invention.

A film of this invention means a curable resin composition of this invention molded in the form of film. The thickness of film, although not limited, is in the range of 3-200 μm, preferably in the range of 5-105 μm.

The method for preparing a film of this invention is not limited and a film is formed, for example, by uniformly dissolving or dispersing a curable resin composition, together with other components if necessary, in a solvent or a mixture of solvents based on aromatic compounds or ketones, applying the solution or dispersion to a resin film such as PET film and drying. The coating operation can be repeated several times, if necessary. It is possible in this case to repeat the coating operation by using plural solvents differing in composition and concentration from one another to finally adjust the composition and amount of resin to the desired values.

A resin-coated metal foil of this invention is composed of a curable resin composition of this invention and a metal foil. The metal foils suitable for use here are, for example, copper foils and aluminum foils. The thickness of metal foil, although not limited, is in the range of 3-200 μm, preferably in the range of 5-105 μm.

The method for preparing a resin-coated metal foil of this invention is not limited and a resin-coated metal foil is prepared, for example, by uniformly dissolving or dispersing a curable resin composition, together with other components if necessary, in a solvent or a mixture of solvents based on aromatic compounds or ketones, applying the solution or dispersion to a metal foil and drying. The coating operation can be repeated several times, if necessary. It is possible in this case to repeat the coating operation by using plural solvents differing in composition and concentration from one another to finally adjust the composition and amount of resin to the desired values.

### EXAMPLES

This invention will be described with reference to the accompanying examples, but is not limited by these examples. Part in the examples means part by weight. The results of measurements given in the examples are obtained by preparing the specimens and testing them according to the methods described below.

1) Molecular Weight and Molecular Weight Distribution of Polymers

The molecular weight and molecular weight distribution of soluble polyfunctional vinyl aromatic copolymers were measured by a GPC (HLC-8120GPC, manufactured by Tosoh Corporation) under the following conditions: solvent, tetrahydrofuran (THF); flow rate, 1.0 ml/min; column temperature, 40° C. The calibration was based on standard polystyrene samples with narrow molecular weight distributions. The molecular weight of copolymers obtained was evaluated as the converted value of polystyrene.

2) Preparation of Specimens for Determination of Glass Transition Temperature (Tg) and Softening Point and Method of Determination

A curable resin composition in solution was applied uniformly to a glass base plate to a dry thickness of 20 μm and heated on a hot plate at 90° C. for 30 minutes. The glass base plate and a film of the resin formed thereon were placed in a thermomechanical analyzer (TMA), heated in a stream of nitrogen up to 220° C. at a rate of 10° C./min and further heated at 220° C. for 20 minutes to remove the residual solvent. The glass base plate was allowed to cool to room temperature, an analytical probe was placed in contact with the specimen in the TMA, the specimen was scanned in a stream of nitrogen while raising the temperature from 30° C. to 360° C. at a rate of 10° C./min and the softening point was obtained by the tangent method. The glass transition temperature (Tg) was obtained from the inflection point of the linear expansion coefficient curve.

The glass transition temperature of a cured film molded by a hot press was determined from the peak of the loss modulus determined with the aid of a dynamic viscoelasticity analyzer while raising the temperature at a rate of 2° C./min.

3) Determination of Thermal Decomposition Temperature and Carbonization Residue

The thermal decomposition temperature and carbonization residue of multi-branched polymers and multi-branched block copolymers were determined by scanning the specimens in a thermogravimetric analyzer (TGA) in a stream of nitrogen while raising the temperature from 30° C. to 650° C. at a rate of 10° C./min. The thermal decomposition temperature was obtained by the tangent method.

4) Dielectric Constant and Dielectric Loss Tangent

Measurements were made by an impedance analyzer in the frequency range from 100 MHz to 1 GHz.

### Synthetic Example 1

In a 1000-ml flask were placed 0.864 mole (123.1 ml) of divinylbenzene, 0.036 mole (5.13 ml) of ethylvinylbenzene, 1.05 millimoles of 1-chloroethylbenzene and 500 ml of dichloroethane (dielectric constant 10.3), a solution of 1.50 millimoles of SnCl₄ in dichloroethane was added at 70° C. and the mixture was allowed to react for 10 minutes. The polymerization reaction was terminated by a small amount of methanol bubbled with nitrogen and then a large amount of methanol was added to the reaction mixture at room temperature to separate a polymer. The polymer thus obtained was washed with methanol, filtered and dried to give 46.33 g of copolymer A (yield 45.3 wt %). The polymerization activity was 936 (g polymer/mmol Sn·hr).

The Mw, Mn and molecular weight distribution of copolymer A were 72800, 13000 and 5.6 respectively. Analyses by ¹³C-NMR and ¹H-NMR indicated that copolymer A had 97 mol % of the constitutional unit derived from divinylbenzene and 3 mol % of the constitutional unit derived from ethylvinylbenzene. Moreover, the indane structure was found to be present in copolymer A. The indane structure was 2.1 mol % of the constitutional units of all the monomers. Furthermore, the mole fraction of the constitutional unit represented by formula (2) to the sum of the constitutional units represented by formulas (2) and (4) or the mole fraction (2)/[(2)+(4)] was 0.99. According to the results by TMA and TGA, the Tg was 291° C., the softening point was 300° C. or above, the thermal decomposition temperature was 418° C. and the carbonaceous residue in a stream of nitrogen at 550° C. was 29%.

### Synthetic Example 2

In a 500-ml flask were placed 0.108 mole (15.3 ml) of divinylbenzene, 0.005 mole (0.64 ml) of ethylvinylbenzene, 0.0375 mole (5.63 g) of acenaphthylene, 0.35 millimole of 1-chloroethylbenzene and 350 ml of dichloroethane (dielectric constant 10.3), a solution of 0.50 millimole of SnCl₄ in dichloroethane was added at 70° C. and the mixture was allowed to react for 3 hours. The polymerization reaction was terminated by a small amount of methanol bubbled with nitrogen and then a large amount of methanol was added to the reaction mixture at room temperature to separate a polymer. The polymer thus obtained was washed with methanol, filtered, dried and weighed to give 20.93 g of copolymer B (yield 91.7 wt %). The polymerization activity was 14.0 (g polymer/mmol Sn·hr).

Copolymer B had 75.8 mol % of the constitutional unit derived from divinylbenzene, 3.2 mol % of the constitutional unit derived from ethylvinylbenzene and 21.0 mol % of the constitutional unit derived from acenaphthylene. Moreover, the indane structure was found to be present in copolymer B. The indane structure was 1.0 mol % of the constitutional units of all the monomers. The mole fraction of the constitutional unit represented by formula (2) was 0.99.

### Synthetic Example 3

In a 500-ml flask were placed 0.072 mole (10.3 ml) of divinylbenzene, 0.003 mole (0.43 ml) of ethylvinylbenzene, 0.075 mole (11.27 g) of acenaphthylene, 0.35 millimole of 1-chloroethylbenzene and 350 ml of dichloroethane (dielectric constant 10.3), a solution of 0.50 millimole of SnCl₄ in dichloroethane was added at 70° C. and the mixture was allowed to react for 3 hours. The polymerization reaction was terminated by a small amount of methanol bubbled with nitrogen and then a large amount of methanol was added to the reaction mixture at room temperature to separate a polymer. The polymer thus obtained was washed with methanol, filtered, dried and weighed to give 16.78 g of copolymer C (yield 68.1 wt %). The polymerization activity was 11.2 (g polymer/mmol Sn·hr).

Copolymer C had 55.5 mol % of the constitutional unit derived from divinylbenzene, 2.3 mol % of the constitutional unit derived from ethylvinylbenzene and 42.2 mol % of the constitutional unit derived from acenaphthylene. Moreover, the indane structure was found to be present in copolymer C. The indane structure was 1.1 mol % of the constitutional units of all the monomers. The mole fraction of the constitutional unit represented by formula (2) was 0.98.

### Synthetic Example 4

In a 1000-ml flask were placed 0.481 mole (68.5 ml) of divinylbenzene, 0.362 mole (51.6 ml) of ethylvinylbenzene, 1.05 millimoles of 1-chloroethylbenzene and 500 ml of dichloroethane (dielectric constant 10.3), a solution of 1.50 millimoles of SnCl₄ in dichloroethane was added at 70° C. and the mixture was allowed to react for 10 minutes. The polymerization reaction was terminated by a small amount of methanol bubbled with nitrogen and then a large amount of methanol was added to the reaction mixture at room temperature to separate a polymer. The polymer thus obtained was washed with methanol, filtered, dried and weighed to give 42.29 g of copolymer D (yield 38.5 wt %). The polymerization activity was 188 (g polymer/mmol Sn·hr).

Copolymer D had 59 mol % of the constitutional unit derived from divinylbenzene and 41 mol % of the constitutional unit derived from ethylvinylbenzene. Moreover, the indane structure was found to be present in copolymer D. The indane structure was 3.5 mol % of the constitutional units of all the monomers. The mole fraction of the constitutional unit represented by formula (2) was 0.99.

### Synthetic Example 5

In a 1000-ml flask were placed 0.30 mole (68.0 ml) of divinylbiphenyl, 0.113 mole (25.9 ml) of ethylvinylbiphenyl, 1.05 millimoles of 1-chloroethylbenzene and 500 ml of dichloroethane (dielectric constant 10.3), a solution of 1.50 millimoles of SnCl₄ in dichloroethane was added at 70° C. and the mixture was allowed to react for 10 minutes. The polymerization reaction was terminated by a small amount of methanol bubbled with nitrogen and then a large amount of methanol was added to the reaction mixture at room temperature to separate a polymer. The polymer thus obtained was washed with methanol, filtered and dried to give 29.57 g of copolymer E (yield 34.6 wt %). The polymerization activity was 132 (g polymer/mmol Sn·hr).

Copolymer E had 75.4 mol % of the constitutional unit derived from divinylbiphenyl and 24.6 mol % of the constitutional unit derived from ethylvinylbiphenyl. Moreover, the indane structure was found to be present in copolymer E. The indane structure was 5.2 mol % of the constitutional units of all the monomers. The mole fraction of the constitutional unit represented by formula (2) was 0.99.

### Synthetic Example 6

In a 1000-ml flask were placed 0.30 mole (54.1 g) of divinylnaphthalene, 0.03 mole (5.47 g) of ethylvinylnaphthalene, 1.05 millimoles of 1-choroethylbenzene and 500 ml of dichloroethane (dielectric constant 10.3), a solution of 1.50 millimoles of SnCl₄ in dichloroethane was added at 70° C. and the mixture was allowed to react for 10 minutes. The polymerization reaction was terminated by a small amount of methanol bubbled with nitrogen and then a large amount of methanol was added to the reaction mixture at room temperature to separate a polymer. The polymer thus obtained was washed with methanol, filtered and dried to give 20.1 g of copolymer F (yield 33.8 wt %). The polymerization activity was 150 (g polymer/mmol Sn·hr).

Copolymer F showed a Mw of 15800, Mn of 3860 and molecular weight distribution of 4.1. Analyses by ¹³C-NMR and ¹H-NMR indicated that copolymer F had 93.1 mol % of the constitutional unit derived from divinylnaphthalene and 6.9 mol % of the constitutional unit derived from ethylvinylnaphthalene. Moreover, the indane structure was found to be present in copolymer F The indane structure was 5.3 mol % of the constitutional units of all the monomers. The mole fraction of the constitutional unit represented by formula (2) was 0.98.

Copolymers A through F are each soluble in toluene, xylene, THF, dichloroethane, dichloromethane and chloroform and the formation of gels was not observed for any of them.

The Mw, Mn, Tg, softening point (s.p.), thermal decomposition temperature (TDT) and carbonization residue (CR) of these copolymers are shown in Table 1.

TABLE 1

| Synthetic | | | | Tg | s.p | TDT | CR |
|---|---|---|---|---|---|---|---|
| Example | Copolymer | Mw | Mn | ° C. | ° C. | ° C. | % |
| 1 | A | 72800 | 13000 | 291 | >300 | 418 | 29 |
| 2 | B | 12000 | 3700 | 286 | >300 | 402 | 25 |
| 3 | C | 15500 | 4400 | 281 | >300 | 395 | 23 |
| 4 | D | 22800 | 7090 | 286 | >300 | 402 | 27 |
| 5 | E | 18400 | 5120 | 291 | >300 | 421 | 32 |
| 6 | F | 15800 | 3860 | 267 | >300 | 417 | 30 |

The following abbreviated and simplified designations were used for certain components used in the Examples.

PPE: Polyphenylene ether with an intrinsic viscosity of 0.45 (manufactured by Mitsubushi Gas Chemical Company Inc.)

Reaction initiator H: Tetramethylbutyl hydroperoxide (PEROCTA H, manufactured by NOF Corporation)

Thermoplastic resin T: Styrene-butadiene copolymer (Tufprene™ A, manufactured by Asahi Kasei Corporation)

Spherical silica S: a grade with an average particle diameter of 0.5 μm (Admafine™ SO-C2, manufactured by ADMATECHS CO., LTD.)

### Example 1

A mixture of 8 g of PPE, 4 g of copolymer A obtained in Synthetic Example 1 and 36 g of toluene was stirred at 90° C. for 60 minutes and 0.5 g of reaction initiator H was added to give a solution of a heat-curable resin composition.

The solution of the heat-curable resin composition was cast onto a polyethylene terephthalate (PET) sheet pasted on a stand to form a film. The film was approximately 100-1 ml thick and nontacky and the composition thus showed good film-forming properties. The film was dried in an air oven at 60° C. for 30 minutes and cured by heat in a press at 180° C. for 1 hour to give a cured film with a thickness of approximately 100 μm.

The cured film showed a tensile strength of 780 kg/cm², elongation of 5.8%, dielectric constant of 2.3 and dielectric loss tangent of 0.001. Moreover, the cured film showed a softening point of above 300° C. and a glass transition temperature (Tg) of 231° C.

### Example 2

A mixture of 6 g of PPE, 3 g of copolymer A, 1 g of thermoplastic resin T, and 36 g of toluene was stirred at 90° C. for 60 minutes and 0.4 g of reaction initiator H was added to give a solution of a heat-curable resin composition.

### Example 3

A mixture of 6 g of PPE, 2 g of copolymer A, 1 g of thermoplastic resin T, 1 g of triallyl isocyanurate (TAIC, manufactured by TOAGOSEI Co., Ltd.) and 36 g of toluene was stirred at 90° C. for 60 minutes and 0.4 g of reaction initiator H was added to give a solution of a heat-curable resin composition.

### Example 4

A mixture of 6 g of PPE, 3 g of copolymer B obtained in Synthetic Example 2, 1 g of thermoplastic resin T and 36 g of toluene was stirred at 90° C. for 60 minutes and 0.4 g of reaction initiator H was added to give a solution of a heat-curable resin composition.

### Example 5

A mixture of 6 g of PPE, 3 g of copolymer C obtained in Synthetic Example 3, 1 g of thermoplastic resin T and 36 g of toluene was stirred at 90° C. for 60 minutes and 0.4 g of reaction initiator H was added to give a solution of a heat-curable resin composition.

### Example 6

A mixture of 6 g of PPE, 3 g of copolymer D obtained in Synthetic Example 4, 1 g of thermoplastic resin T and 36 g of toluene was stirred at 90° C. for 60 minutes and 0.4 g of reaction initiator H was added to give a solution of a heat-curable resin composition.

### Example 7

A mixture of 6 g of PPE, 3 g of copolymer E obtained in Synthetic Example 5, 1 g of thermoplastic resin T and 36 g of toluene was stirred at 90° C. for 60 minutes and 0.4 g of reaction initiator H was added to give a solution of a heat-curable resin composition.

### Example 8

A mixture of 6 g of PPE, 3 g of copolymer F obtained in Synthetic Example 6, 1 g of thermoplastic resin T and 36 g of toluene was stirred at 90° C. for 60 minutes and 0.4 g of reaction initiator H was added to give a solution of a heat-curable resin composition.

### Example 9

A mixture of 12 g of PPE, 6 g of copolymer D obtained in Synthetic Example 4, 2 g of thermoplastic resin T, 8 g of spherical silica S and 80 g of toluene was stirred at 90° C. for 60 minutes and 0.8 g of reaction initiator H was added to give a solution of a heat-curable resin composition.

The solutions of the heat-curable resin compositions obtained in Examples 2-9 were processed as in Example 1 to form films. The films each showed a thickness of approximately 100 μm and nontacky and the compositions thus showed good film-forming properties. The films were dried in an air oven at 60° C. for 30 minutes and then cured by heat in a press at 180° C. for 1 hour to give cured films with a thickness of approximately 100 μm.

Table 2 shows the tensile strength, elongation, dielectric constant, dielectric loss tangent, softening point (s.p.) and glass transition temperature (Tg) of the cured films obtained in Examples 1-9.

TABLE 2

| | tensile | | | | | |
|---|---|---|---|---|---|---|
| | strength | elongation | dielectric | dielectric | s.p. | Tg |
| Example | kg/cm² | % | constant | loss tangent | ° C. | ° C. |
| 1 | 780 | 5.8 | 2.3 | 0.001 | >300 | 231 |
| 2 | 690 | 9.8 | 2.2 | 0.001 | >300 | 223 |
| 3 | 610 | 8.8 | 2.5 | 0.003 | >300 | 192 |
| 4 | 620 | 7.7 | 2.3 | 0.002 | >300 | 201 |
| 5 | 605 | 6.8 | 2.4 | 0.003 | >300 | 204 |
| 6 | 670 | 10.7 | 2.4 | 0.001 | >300 | 216 |
| 7 | 720 | 11.3 | 2.3 | 0.001 | >300 | 245 |
| 8 | 690 | 10.4 | 2.3 | 0.001 | >300 | 226 |
| 9 | 890 | 5.1 | 2.7 | 0.003 | >300 | 231 |

### Example 10

A mixture of 60 g of PPE, 30 g of copolymer D obtained in Synthetic Example 4, 10 g of thermoplastic resin T, 40 g of spherical silica S and 400 g of toluene was stirred at 90° C. for 60 minutes and 4 g of reaction initiator H was added to give a solution of a heat-curable resin composition.

A) Curable Composite Material

This solution was used to impregnate glass fabrics (E glass, weight 71 g/m²) and the impregnated glass cloth was dried in an air oven at 50° C. for 30 minutes to give a prepreg with a resin content (RC) of 69%.

The prepreg was pasted on a core material in which throughholes with a diameter of 0.35 mm were arranged at a pitch of 5 mm and the number of throughholes not filled with the resin was 0 out of 4,500.

B) Laminate

Several sheets of the aforementioned curable composite material were piled one upon another so that the thickness after curing became approximately 0.6-1.0 mm, 35 μm-thick copper foils were placed on both sides of the pile of the curable composite materials and the assembly was molded and cured by a press to give a laminate. The curing operation in each example was carried out under a pressure of 30 kg/cm² by raising the temperature to 180° C. at a rate of 3° C./min and maintaining the temperature there for 90 minutes.

The properties of the laminates thus obtained were measured as follows.

1) Resistance to trichloroethylene: The laminate from which the copper foil had been removed was cut into a square with 25-mm sides, the square was boiled in trichloroethylene for 5 minutes and the change in external appearance was visually observed (according to a procedure based on JIS C 6481).

2) Dielectric constant and dielectric loss tangent: Measurements were made at 1 MHz (according to a procedure based on JIS C 6481).

3) Solder heat resistance: The laminate from which the copper foil had been removed was cut into a square with 25-mm sides, the square was allowed to float in a solder pot for 120 seconds and the change in external appearance was visually observed (according to a procedure based on JIS C 6481).

4) Glass transition temperature (Tg): A specimen cut from the laminate was tested by a TMA.

No change in the external appearance of the laminate was observed in the test for resistance to trichloroethylene or in the test for solder heat resistance. The Tg was 241° C., the dielectric constant was 2.9 and the dielectric loss tangent was 0.003.

### Example 11

The solution prepared in Example 10 was applied to an 18 μm-thick electrolytic copper foil, dried in an air dryer for 10 minutes and then dried in an air oven at 60° C. for 30 minutes to give a resin-coated copper foil. The thickness of resin on the copper foil was 80 μm. The resin-coated copper foil was put on the core material of Example 9 and cured by pressing at 180° C. for 90 minutes under a pressure of 30 kg/cm². Throughholes unfilled with the resin were not confirmed.

Curable resin compositions of this invention show excellent chemical resistance, dielectric characteristics, heat resistance, flame retardancy and mechanical properties and low water absorption after curing and they can be used in dielectric materials, insulating materials, heat-resistant materials, structural materials and the like in the electrical and space and aircraft industries. In particular, they can be used in single-sided, double-sided and multilayer printed circuit boards, flexible printed circuit boards and buildup boards.

What is claimed is:

1. A curable resin composition which comprises
component (A); a polyphenylene ether resin having a constitutional unit represented by the following formula (1) 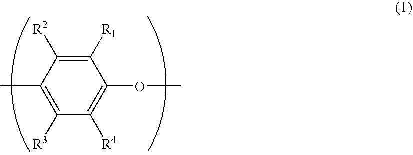
wherein R¹ and R⁴ each independently represent halogens, primary or secondary lower alkyl groups, haloalkyl groups, aminoalkyl groups, hydrocarbyloxy groups, aromatic hydrocarbon groups or halohydrocarbyloxy groups with halogen separated from oxygen by at least two carbon atoms, R² and R³ each independently represent hydrogen, halogens, primary or secondary lower alkyl groups, haloalkyl groups, hydrocarbyloxy groups, aromatic hydrocarbon groups or halohydrocarbyloxy groups with halogen separated from oxygen by at least two carbon atoms and
component (B); a solvent-soluble polyfunctional vinyl aromatic copolymer having constitutional units derived from divinyl aromatic compound (a) and monovinyl aromatic compound (b), having 20 mol % or more of a repeating unit derived from divinyl aromatic compound (a) and constitutional units represented by the following formulas (2) and (3) 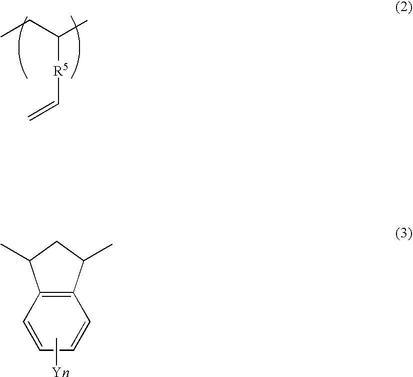
wherein R⁵ represents an aromatic hydrocarbon group containing 6-30 carbon atoms, Y represents a saturated or unsaturated aliphatic hydrocarbon group, an aromatic hydrocarbon group or an unsubstituted or substituted aromatic ring condensed with the benzene ring of the indane ring and n is an integer of 0-4 and is formulated from 30-98 wt % of component (A) and 2-70 wt % of component (B) on the basis of the sum of components (A) and (B).

2. A curable resin composition as described in claim 1 wherein the composition comprises a thermoplastic resin as component (C) in addition to components (A) and (B) and the proportion of component (C) to the sum of components (A), (B) and (C) is 2-40 wt %.

3. A curable resin composition as described in claim 2 wherein the composition comprises a filler as component (D) in addition to components (A), (B) and (C) and the proportion of component (D) to the sum of components (A), (B), (C) and (D) is 2-90 wt %.

4. A film molded from a curable resin composition described in claim 1.

5. A curable composite material comprising a curable resin composition described in claim 1 and a base material wherein said base material is contained at a proportion of 5-90 wt %.

6. A cured composite material obtained from a curable composite material described in claim 5.

7. A laminate comprising a layer of a cured composite material described in claim 6 and a metal foil.

8. A resin-coated metal foil which has a film of a curable resin composition described in claim 1 formed on one side of a metal foil.

9. A curable resin composition as described in claim 1 wherein component (B) or a solvent-soluble polyfunctional vinyl aromatic copolymer has 20 mol % or more of a repeating unit derived from divinyl aromatic compound (a), constitutional units represented by formula (2) and the following formula (4) 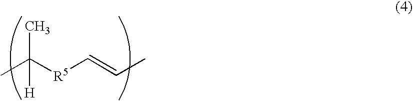
wherein R⁵ represents an aromatic hydrocarbon group containing 6-30 carbon atoms in a ratio of 50 mol % or more as the mole fraction of the constitutional unit represented by formula (2) to the sum of the constitutional units represented by formulas (2) and (4) and an indane structure represented by formula (3) in the backbone.
